(19) United States
(12) Patent Application Publication
(10) Pub. No.: US 2023/0316136 A1
(43) Pub. Date: Oct. 5, 2023

(54) MACHINE LEARNING MODELS WITH INTEGRATED UNCERTAINTY

(71) Applicant: Cypress Semiconductor Corporation, San Jose, CA (US)

(72) Inventors: Niall LYONS, Irvine, CA (US); Anand DUBEY, Munchen (DE); Avik SANTRA, Irvine, CA (US); Ashutosh PANDEY, Irvine, CA (US)

(73) Assignee: Cypress Semiconductor Corporation, San Jose, CA (US)

(21) Appl. No.: 18/096,444

(22) Filed: Jan. 12, 2023

Related U.S. Application Data
(60) Provisional application No. 63/401,978, filed on Aug. 29, 2022.
(60) Provisional application No. 63/327,254, filed on Apr. 4, 2022.

(51) Int. Cl. G06N 20/00

(52) U.S. Cl. CPC G06N 20/00

(57) ABSTRACT

A system includes memory and a processing device, operatively coupled to the memory, to obtain an input signal corresponding to data obtained from a data source, extract a set of features using the input signal, generate a set of feature tracking data from the set of features, compress a machine learning model to obtain a compressed model by identifying a subset of features based on the set of tracking data, and use the compressed model to make a prediction based on the set of feature tracking data. The set of features includes a set of confidence features and a set of uncertainty features, and the set of feature tracking data includes a set of confidence feature tracking data and a set of uncertainty feature tracking data.

### RELATED APPLICATIONS

This application claims the benefit of U.S. Provisional Application No. 63/401,978, filed Aug. 29, 2022, and U.S. Provisional Application No. 63/327,254, filed Apr. 4, 2022, the entire contents of which are incorporated herein by reference.

### BACKGROUND

Machine learning models can be used to make predictions from a set of input data. Input data can include image data, audio data, time series data, etc. For example, a machine learning model can be a classification model that predicts a class. A machine learning model can be trained using training data to make predictions. Examples of machine learning models include supervised learning models that are trained with labeled training data, unsupervised learning models that are trained without labeled training data, and semi-supervised learning models that are trained using a combination of labeled training data and unlabeled training data. Examples of machine learning models include neural networks (e.g., deep learning models), decision trees, support vector machines (SVMs), regression models, Bayesian models, etc.

### BRIEF DESCRIPTION OF THE DRAWINGS

The disclosure is illustrated by way of example, and not of limitation, in the figures of the accompanying drawings.

FIG. 1 is a block diagram of an example system for implementing a machine learning model with integrated uncertainty, according to some embodiments.

FIGS. 2-3 are block diagrams of example architectures of a prediction system, according to some embodiments.

FIG. 4 is a flow diagram of an example method of implementing a machine learning model with integrated uncertainty, according to some embodiments.

FIG. 5 is a block diagram of an example computer system in which embodiments of the present disclosure can operate.

### DETAILED DESCRIPTION

Machine learning models can be trained to make predictions with respect to a task. One example of a task is activity recognition. Activity recognition generally refers to the task of identifying an activity that is being performed by an object. One example of activity recognition is human activity recognition for identifying an activity that is being performed by a human. Activity recognition can be implemented by a device that includes one or more sensor modalities. Examples of sensor modalities include camera, radar, infrared, thermal imaging, inertial measurement unit (IMU), etc. An IMU is a device that can include at least one sensor for measuring data that can be used to derive one or more parameters related to the activity of an object. Examples of parameters include acceleration, force (e.g., specific force), rotational rate and orientation. Examples of IMU sensors include accelerometers, gyroscopes, magnetometers, etc. For example, an accelerometer can be used to detect acceleration and a gyroscope can be used to detect rotational rate. Machine learning models used for activity recognition can be optimized using categorical distribution-based loss functions, such as SoftMax.

An activity recognition system can be an IMU-based activity recognition system that can identify an activity based on the data measured by at least one IMU sensor. For example, an IMU sensor can be an accelerometer, a gyroscope, a magnetometer, etc. In some implementations, an activity recognition system is a human activity recognition (HAR) system that can be used to identify at least one human activity. Examples of human activities that can be recognized by a HAR system include idle activity, jumping activity, sitting activity, squatting activity, standing activity, gait activity (e.g., walking, running, skipping), climbing activity (e.g., stairclimbing activity), kicking activity, sports activity (e.g., golfing), video game activity, etc.

More specifically, an activity recognition system can include a machine learning model (MLM) that can be trained to predict an activity or gesture related to an activity. Various MLM-based activity recognition systems can classify activities by allowing separability of activity in the feature space. Examples of MLM-based activity recognition systems include convolutional neural network (CNN)-based activity recognition systems, temporal CNN-based activity recognition systems, long short-term memory (LSTM)-based activity recognition systems, bilateral LSTM (biLSTM)-based activity recognition systems, multilayer perceptron (MLP)-based activity recognition systems, support vector machine (SVM)-based activity recognition systems, etc.

An MLM of an activity recognition system can be trained to make an activity prediction based on corresponding input data derived from sensor data. For example, an MLM can be trained to classify the input data into a particular activity class. Thus, an activity that the MLM was trained to identify can be referred to as a “known activity” (e.g., a “known activity class”), where an activity that the MLM was not previously trained to identify can be referred to as an “unknown activity” (e.g., an “unknown activity class”). Moreover, for a particular set of data, there can be cross-correlation with respect to multiple activities. For example, standing and jumping can each involve some upward motion of at least the upper body (i.e., torso) relative to the ground. Thus, data obtained by one or more IMU sensors can be simultaneously predictive of both standing and jumping during periods of downward motion. Accordingly, if standing is a known activity for an MLM and jumping is an unknown activity for the MLM (i.e., the MLM has been trained to predict standing activity and not jumping activity), then the MLM may incorrectly predict an activity being performed by a person as a standing activity even though the person is performing a jumping activity.

Some activity recognition systems employ MLMs built for a closed-world environment (i.e., static environment), in which the MLMs make predictions based on closed-world assumptions. In practice, such activity recognition systems can be expected to encounter variations in measurements due to factors such as sensor degradation, unknown environments and/or sensor noise. For example, sensor noise can be invariably present in sensor data and may not vanish with a theoretically infinite amount of data. Such variations can introduce uncertainty and lead to the identification of potentially unknown activities. Although performance metrics may be high for some MLM-based activity recognition systems, some MLM-based activity recognition systems may fail to provide sufficient discrimination between different activity classes. Sufficient discrimination may be needed for an activity recognition system to operate in an open-world environment under the variations in measurements described above. For example, real-time continuous sensing and activity classification can have challenges due to missed signals and/or low-confidence predictions during transitions between different activities.

To address at least the above-noted deficiencies, embodiments described herein provide for systems and methods that can implement MLMs with integrated uncertainty to achieve improved prediction accuracy and provide a confidence or reliability score. An MLM described herein can be trained to perform any suitable machine learning task. In some embodiments, a machine learning task is an activity recognition task for activity recognition. For example, an MLM can be used by an activity recognition system to predict an activity of an object based on sensor data. In some embodiments, the activity recognition system is an IMU-based activity recognition system. In some embodiments, an activity recognition system is an HAR system. However, such embodiments should not be considered limiting.

For example, embodiments described herein can enable a complete Bayesian formulation for a machine learning task over feature extraction and prediction stages. As a result, embodiments described herein can show robustness against an unknown class (e.g., activity class) and can reject the unknown class with high uncertainty over classification scores. That is, embodiments described herein can be used to successfully and reliably discriminate new unseen highly correlated targets. Embodiments described herein can use metric-based learning and temporal smoothening to improve prediction and classification. Embodiments described herein can compress an MLM using a set of model compression parameters. More specifically, performing model compression can include performing dimensionality reduction to reduce the number of parameters (e.g., features) used to train the MLM. For example, the set of model compression parameters can include a set of Shapley values. The compression can reduce the size of the MLM while retaining separability of both known activity classes and unknown activity classes. Accordingly, embodiments described herein can achieve improved activity recognition performance in various activity recognition applications, as well as activity recognition MLM training with improved resource efficiency and decreased computational power.

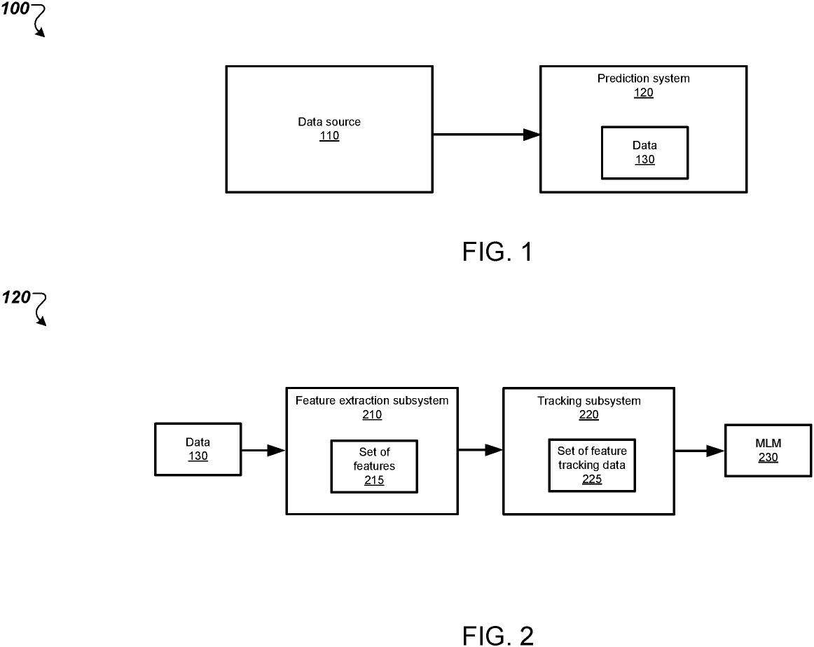

Embodiments described herein can improve the performance of various applications performed by devices that can perform machine learning tasks (e.g., activity recognition), such as smart home applications (e.g., heating, ventilation, air conditioning, lighting), healthcare monitoring applications, human-machine interface system applications, etc. Examples of devices include, without limitation, automobiles, home appliances (e.g., refrigerators, washing machines, etc.), personal computers (e.g., laptop computers, notebook computers, etc.), mobile computing devices (e.g., tablets, tablet computers, e-reader devices, etc.), mobile communication devices (e.g., smartphones, cell phones, personal digital assistants, messaging devices, pocket PCs, etc.), connectivity and charging devices (e.g., hubs, docking stations, adapters, chargers, etc.), audio/video/data recording and/or playback devices (e.g., cameras, voice recorders, hand-held scanners, monitors, etc.), body-wearable devices, and other similar electronic devices. For example, embodiments described herein can be used to make predictions, along with confidence scores (e.g., reliability) of the predictions, such that the system can fail without posing a threat for safety-critical solutions. Further details regarding implementing activity recognition with integrated uncertainty will be described herein below with reference to FIGS. 1-5.

The following description sets forth numerous specific details such as examples of specific systems, components, methods, and so forth, in order to provide a good understanding of various embodiments of the techniques described herein for implementing activity recognition with integrated uncertainty. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

FIG. 1 is a block diagram of an example system 100 for implementing a machine learning model with integrated uncertainty, according to some embodiments. For example, the system 100 can include a data source 110 operatively coupled to a prediction system 120. The data source 110 can provide (e.g., generate) data that can be used by the prediction system 120 to make a prediction. More specifically, the prediction can be made in the context of performing a machine learning task. For example, the data source 110 can be included in at least one of: an automobile, home appliance, personal computer, mobile computing device, mobile communication device, connectivity and charging device, audio/video/data recording and/or playback devices, body-wearable devices, etc.

The prediction system 120 can receive data 130 from the data source 110, and use a machine learning model to make a prediction based on the data 130. In some embodiments, the data 130 received from the data source 110 is raw data, and the prediction system 120 can generate an input signal from the raw data. In some embodiments, the data 130 is the input signal. For example, the data source 110 and/or some other device can generate the input signal from the raw data.

In some embodiments, the data source 110 includes a sensor device including one or more sensors for generating raw sensor data, and the prediction system 120 is an activity recognition system. In some embodiments, the raw sensor data includes time series data. In some embodiments, the data source 110 includes an IMU device including one or more IMU sensors and the prediction system 120 is an IMU-based activity recognition system. For example, the one or more IMU sensors can include at least one of: an accelerometer, a gyroscope, a magnetometer, etc.

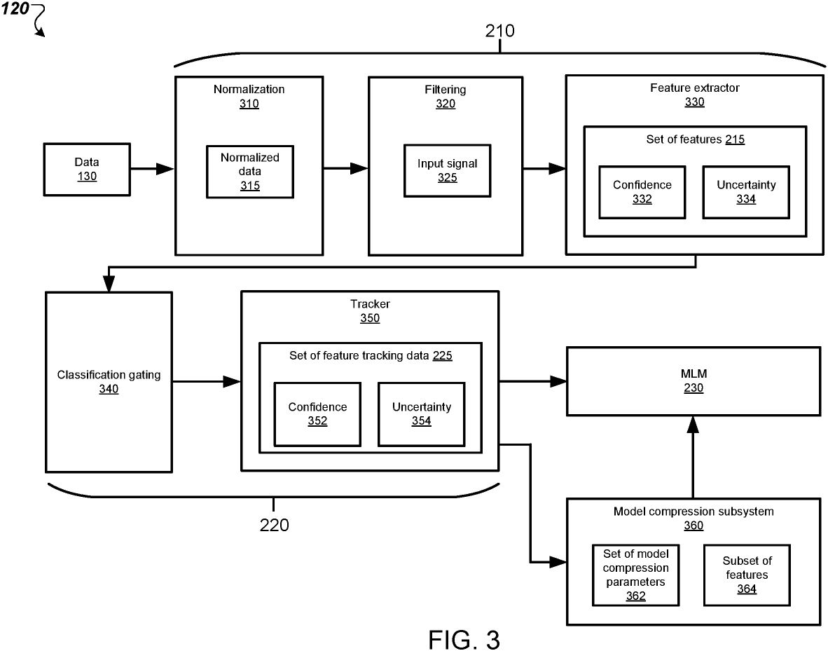

The activity recognition system can implement a machine learning model to predict at least one activity based on the data 130. In some embodiments, the prediction system 120 is a human activity recognition (HAR) system that can implement a machine learning model to predict at least one human activity based on the data 130. Examples of human activity include idle activity, jumping activity, sitting activity, squatting activity, standing activity, gait activity (e.g., walking, running, skipping), climbing activity (e.g., stairclimbing activity), kicking activity, sports activity (e.g., golfing), video game activity, etc. Further details regarding the prediction system 120 will now be described below with reference to FIG. 2.

FIG. 2 is a block diagram of an example architecture of the prediction system 120, according to some embodiments. In some embodiments, the prediction system 120 is an activity recognition system. For example, the prediction system 120 can be a human activity recognition system.

As shown, the prediction system 120 can include a feature extraction subsystem 210. The feature extraction subsystem 210 can extract a set of features from the data 130. In some embodiments, the set of features includes at least one feature vector. In some embodiments, the feature extraction subsystem 210 includes an encoder to extract the set of features from the data 130. In some embodiments, the feature extraction subsystem 210 includes a set of preprocessing components. If the data 130 includes raw data (e.g., raw sensor data), the set of preprocessing components can convert the data 130 into the input signal. For example, the set of preprocessing components can include at least one of: a normalization component to generate normalized data by normalizing the raw data, or a filter component to generate the input signal by filtering the normalized data.

The prediction system 120 can further include a tracking subsystem 220. The tracking subsystem 220 can generate a set of feature tracking data 225 by recursively tracking the at least one set of features and associated uncertainty. The set of feature tracking data 225 can represent a transformation of the set of features 215 to a tracked feature vector/embedding space. The set of feature tracking data 225 data can used to implement a machine learning model (MLM) 230. The MLM 230 can predict an activity based on the set of feature tracking data. That is, the MLM 230 can make at least one prediction. For example, the MLM 230 can classify, based on the set of feature tracking data, an activity into a particular class. In some embodiments, the MLM 230 is a classifier.

The MLM 230 can have any suitable model architecture. In some embodiments, the MLM 230 is a Bayesian classifier. In some embodiments, the MLM 230 is a fully-connected (FC) model including at least one FC layer. In some embodiments, the MLM 230 is a fully-connected Bayesian neural network (FC-BNN) model. For example, the FC-BNN model can be a four-layered FC-BNN model. Further details regarding the prediction system 120 will now be described below with reference to FIG. 3.

FIG. 3 is a block diagram of an example architecture of the prediction system 120, according to some embodiments. The prediction system 120 includes the feature extraction subsystem 210, the tracking subsystem 220, and the MLM 230, as described above with reference to FIG. 2.

In some embodiments, the feature extraction subsystem 210 includes a set of preprocessing components, including a normalization component 310 and a filtering component 320. For example, if the data 130 includes raw data from the data source 110 described above, the normalization component 310 can receive the data 130 and normalize the data 130 to generate normalized data 315. The filtering component 320 can filter the normalized data to generate an input signal 325.

The feature extraction subsystem 210 further includes a feature extractor 330 that can extract the set of features 215 from the input signal 325. For example, the feature extractor 330 can be trained to follow variational inference by mapping input data to a distribution over a plausible latent feature embedding. In some embodiments, the feature extractor 330 includes an encoder, and the set of features 215 includes a feature vector.

In some embodiments, the set of features 215 corresponds to a Bayesian representation that indicates a strength of correlation between the set of features 215 and an activity (e.g., activity class) using associated uncertainty. For example, the set of features 215 can include a set of confidence features 332 (e.g., confidence feature vector) and a set of uncertainty features 334 (e.g., uncertainty feature vector). In some embodiments, the set of confidence features 332 is a set of mean-based features and the set of uncertainty features 334 is a set of variance-based features related to the set of mean-based features (e.g., variance or standard deviation). For example, the set of confidence features 332 can be a mean feature vector, and the set of uncertainty features 334 can be a variance-based feature vector (e.g., variance feature vector or standard deviation feature vector). Generally, high variance or standard deviation with respect to the mean can be correlated with a high amount of uncertainty. Accordingly, if the set of variance-based features indicates sufficiently high variance/standard deviation of features with respect to the set of mean-based features, this means that the feature extractor 330 may have performed a sub-optimal extraction of the set of features 215 and/or the input signal 325 may have been noisy.

In some embodiments, the tracking subsystem 220 includes a classification gating component 340. The classification gating component 340 can be used to smooth the output of the feature extractor 330 to address potentially noisy data.

The tracking subsystem 220 includes a tracker 350 that can generate the set of feature tracking data 225. The tracker 350 can preserve correlations between temporal data of the input signal 325 (e.g., rate of change of the input signal 325) and features by tracking the temporal data as well as feature changes. In some embodiments, the tracker 350 generates the set of feature tracking data 225 by recursively tracking features and associated uncertainty based on the output of the classification gating component 340. For example, the set of feature tracking data 225 can include a set of confidence feature tracking data 352 and a set of uncertainty feature tracking data 354. In some embodiments, the set of confidence feature tracking data 352 is a set of mean-based feature tracking data, and the set of uncertainty feature tracking data 354 is a set of variance-based feature tracking data (e.g., variance or standard deviation). In some embodiments, the set of confidence feature tracking data 352 is a confidence feature tracking data vector, and the set of uncertainty feature tracking data 354 is an uncertainty feature tracking data vector. For example, the set of confidence feature tracking data 352 can be a mean-based feature tracking data vector, and the set of uncertainty feature tracking data 354 can be a variance-based feature tracking data vector (e.g., variance or standard deviation).

The set of feature tracking data 225 can be used to implement the MLM 230. For example, implementing the MLM can include training the MLM 230 to obtain a trained model. As another example, the MLM 230 is a trained model, and implementing the MLM can include performing an inference using the trained model.

In some embodiments, the tracker 350 implements a filter to generate the set of feature tracking data 225. In some embodiments, the filter is a Kalman filter. The set of feature tracking data 225 can represent a value of an activity and an associated uncertainty with the activity. The tracker 350 can track features over time, while handling spurious misclassifications and smoothening features towards an activity cluster centroid. In some embodiments, the tracker 350 assumes a state vector as a Gaussian random variable distribution. This can enable the use of both the value of a current state of the activity, as well as the associated uncertainty associated with the activity. The tracker 350 can be used to learn the projection of time series input data into an embedding vector, where data from similar activities are grouped together while dissimilar activities are grouped further apart. More specifically, the tracker 350 can enable (complete) Bayesian inference, which refers to the estimation of features associated with an activity class. Due to the nature of the state vector, which carries a probability distribution, an association metric can be used by the tracker 350 to perform the association. In some embodiments, the association metric is a metric representing a measure of distance between a point and a distribution. For example, the associated metric can be the Mahalanobis distance. The association metric can act as a multivariate Euclidean norm, which is a function of both the mean and (co)variance of the predicted state vector.

Although neural networks can act as universal approximation functions for complex and non-linear functions between inputs and outputs, one limitation of deterministic NNs is that they are frequentist in nature. This can be understood from the formulation of a cost function during training (e.g., negative log likelihood). In some implementations, maximum likelihood estimation (MLE) is performed over training data given a set of parameters. For example:

$${w}^{\text{MLE}} = arg \text{} {max}_{w} log P \left(D \left|w\right)\right) \qquad \text{(1)}$$

where w represent the set of parameters, D = {(xᵢ, yᵢ)} represents a set of training data and w^{MLE} represents the MLE.

Some neural networks can overfit data and fail to generalize using MLE. In some implementations, maximum a posteriori (MAP) estimation is performed over the training data. For example, the MAP for the set of parameters, w^{MAP} can be determined as:

$${w}^{\text{MAP}} = arg \text{} {max}_{w} log P \left(w \left|D\right)\right) \qquad \text{(2)}$$

Although both MLE and MAP provide point estimates of parameters, they still are limited with respect to quantifying uncertainty over neural network estimates. To address this, a posterior predictive distribution can be employed to reject unseen data by quantifying associated uncertainty over its prediction. For example, a posterior prediction distribution p(y|x, D) can be determined as:

$$p \left(y \left|x\right) , D\right) = \int p \left(y \left|x , w\right)\right) p \left(w \left|D\right)\right) d w \qquad \text{(3)}$$

The MLM 230 can be an FC-BNN model including a prediction layer and hidden layer(s) to help propagate both aleatoric and epistemic uncertainty caused due to randomness or error in true estimation from the tracker 350 and lack of model knowledge due to, for example, limited data. Due to the distribution nature of parameters of the MLM 230, instead of typical direct propagation, weight distribution parameters can be learned through variational inference. This can be done by minimizing the Kullback-Leibler (KL) divergence between a variational distribution q(w|θ) and the true posterior p(w) with respect to a distribution parameterized by θ = (µ, σ) as:

$$\begin{matrix}F \left(D , θ\right) = K L \left(q \left(w \left|θ\right)\right) \left‖p \left(w\right)\right)\right) - {E}_{q \left(w \left|θ\right)\right)} log p \left(D \left|w\right)\right) \\ = {E}_{q \left(w \left|θ\right)\right)} log q \left(w \left|θ\right)\right) - {E}_{q \left(w \left|θ\right)\right)} log p \left(w\right) - {E}_{q \left(w \left|θ\right)\right)} log p \left(D \left|w\right)\right)\end{matrix} \qquad \text{(4)}$$

where µ is the mean-based feature vector and σ is the variance-based feature vector (e.g., variance or standard deviation). For example, the distribution can be a Gaussian distribution.

As can be seen from equation (4), all three terms are expectation terms with respect to the variational distribution q(w|θ). While the first two terms are data-independent and can be evaluated layer-wise, the last term is data-dependent and can be evaluated at the end of the forward-pass. Due to the multi-variant probability distribution nature of the model, it may not be possible to compute the gradient during backpropagation. Thus, optimization can be done by taking advantage of stochastic sampling during the forward pass and re-parameterization during the backward pass.

In some embodiments, and as shown, the prediction system 120 further includes a model compression subsystem 360. The model compression subsystem 360 can compress the MLM 230 (e.g., during training). For example, the model compression subsystem 360 can use a set of model compression parameters 362 to identify, from the set of features 215 based on the set of feature tracking data 225, a subset of features 364. The subset of features 364 can include one or more features determined to be sufficiently important for classifying the activity. For example, the set of model compression parameters 362 can implement a feature explainability method to identify feature importance.

In some embodiments, the set of model compression parameters 362 includes a set of Shapley values. The set of Shapley values can be used to implement a Shapley-value-based feature explainability method. However, the set of model compression parameters 362 can include any suitable parameters. For example, the set of model compression parameters 362 can include a set of Local Interpretable Model-agnostic Explanation (LIME) parameters to implement a LIME-based feature explainability method. Accordingly, the set of model compression parameters 326 can be used to perform dimensionality reduction with respect to the features, which can reduce the size of the MLM 230.

An example of method of implementing the MLM 230 that uses a training procedure performed using a set of Shapley values will now be described. Assume that a training set D^{m}, a validation set D^{ν} and a test set D^{t} that are used to optimize an optimization parameter θ^{m} of the MLM 230 are initialized. Moreover, an initial optimization parameter θ⁰ of the MLM 230 is initialized. A baseline training of the MLM 230 can be performed by training the initial set of MLM parameters θ⁰ using D^{m} and D^{ν}, and determining an accuracy of the set of MLM parameters θ^{m} by evaluating θ^{m} based on D^{t}. After performing the baseline training of the MLM 230, a set of Shapley values can be generated (e.g., estimated) for each input feature (e.g., feature vector) into the MLM 230, where the set of Shapley values = [shap₁, shap₂,...,shap_{n]}. More specifically, there can be n input features, and shapᵢ is defined for input feature i. For each shapᵢ, it is determined whether the input feature i satisfies a threshold condition, and the input feature i is selected for the subset of features 364 if the shapᵢ satisfies the threshold condition. In some embodiments, the determination is made based on the maximum Shapley value of the set of Shapley values and the minimum Shapley value of the set of Shapley values. For example, determining whether shapᵢ satisfies the threshold condition can include determining whether shapᵢ is greater than or equal to the threshold Shapley value. If shapᵢ is greater than or equal to the threshold Shapley value, then input feature i can be selected for the subset of features 364. Otherwise, input feature i can be removed. Hidden units of the MLM 230 can be reduced in parallel.

In some embodiments, the feature extractor 330 is a triplet loss-based feature extractor (e.g., encoder). More specifically, the feature extractor 330 can enable a metric learning based triplet loss function for triplet-based optimization. In some embodiments, the feature extractor 330 is a quadruplet loss-based feature extractor (e.g., encoder). More specifically, the feature extractor 330 can enable a metric learning based quadruplet loss function for quadruplet-based optimization.

A triplet and/or quadruplet loss function can be computed in a latent space z based on the set of features 215 (e.g., feature vector) output by the feature extractor 330. Triplet and/or quadruplet-based optimization can be performed using online hard and semi-hard pairs following a min-max distance learning between selected pairs.

An example triplet loss function is provided as follows:

$${L}_{\text{triplet}} = max \left({\left‖{q}_{ϕ} \left({x}_{a}\right) - {q}_{ϕ} \left({x}_{p}\right)\right‖}^{2} - {\left‖{q}_{ϕ} \left({x}_{a}\right) - {q}_{ϕ} \left({x}_{n}\right)\right‖}^{2} + {α}_{\text{margin}} , 0\right) \qquad \text{(5)}$$

where xₐ is an anchor sample (i.e., random sample), xₚ is a positive sample from the same class as the anchor sample, xₙ is a negative sample from a different class from the anchor sample, α_{margin} is a hyperparameter defining the boundary condition between similar and dissimilar pairs, and ||·|| is the Euclidean distance function. The distance between an anchor sample and a positive sample, d (q_{ϕ}(xₐ), q_{ϕ}(xₚ)), is minimized (i.e., d (q_{ϕ}(xₐ), q_{ϕ}(xₚ)) = 0) and the distance between the anchor sample a negative sample, d (q_{ϕ} (xₐ), q_{ϕ}(xₙ)), can be maximized by making d (q_{ϕ} (xₐ), q_{ϕ}(xₙ)) greater than d (q_{ϕ}(xₐ), q_{ϕ}(xₚ)) + α_{margin}.

An example quadruplet loss function is provided as follows:

$$\begin{matrix}{L}_{\text{quadruplet}} = {\sum }_{i , j , k}^{N} \left‖q {\left({x}_{i} {}_{,} {x}_{j}\right)}^{2} - q {\left({x}_{i ,} {x}_{k}\right)}^{2} + {α}_{1}\right‖ + \\ {\sum }_{i , j , k , l}^{N} \left‖q {\left({x}_{i} {}_{,} {x}_{j}\right)}^{2} - q {\left({x}_{l ,} {x}_{k}\right)}^{2} + {α}_{2}\right‖\end{matrix} \qquad \text{(6)}$$

Where samples xᵢ and xⱼ belong to the same class and represent the anchor sample and a positive sample, and samples xₖ and xᵢ belong to two different classes, which are also not an anchor class. Moreover, α₁ and α₂ are respective hyperparameters. Accordingly, in contrast to the triplet loss function, the quadruplet loss function can include another negative sample at the cost of an additional hyperparameter. This can improve inter-class distance and/or intra-class distance determinations.

An overall loss function, Lₒᵥₑᵣₐₗₗ, can be provided as follows:

$${L}_{\text{overall}} = A \times {L}_{\text{recon}} + B \times \left({L}_{\text{KL}} + {L}_{\text{metric}}\right) \qquad \text{(7)}$$

Where L_{metric} is the triplet loss function or the quadruplet loss function, L_{KL} is the KL divergence loss to minimize deviation from Gaussianity with 0 mean and unit variance, L_{recon} is a reconstruction loss function for reconstructing denoised data (e.g., mean-squared error reconstruction), and A and B are constants that sum to one. For example, A = 0.7 and B = 0.3. However, such an example should not be considered limiting.

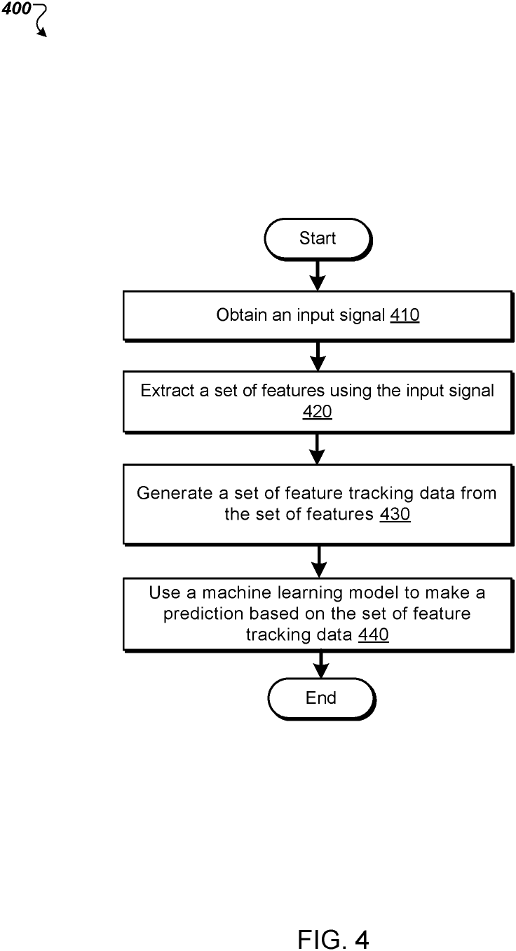

FIG. 4 is flow diagram of a method 400 of implementing a machine learning model with integrated uncertainty, according to some embodiments. The method 400 may be performed by processing logic that comprises hardware (e.g., circuitry, dedicated logic, programmable logic, microcode, etc.), software, firmware, or a combination thereof. In some embodiments, the method 400 is performed by the prediction system 120 of FIGS. 1-3. In some embodiments, activity recognition is human activity recognition.

At block 410, processing logic obtains an input signal. The input signal can correspond to data provided by a data source. In some embodiments, obtaining the input signal includes receiving raw data from the data source, and generating the input signal from the raw data. In some embodiments, generating the input signal from the raw data includes normalizing the raw sensor data to generate normalized sensor data, and filtering the normalized sensor data to generate the input signal. In some embodiments, obtaining the input signal includes receiving the input signal. For example, the input signal can be received from a data source. As another example, the input signal can be received from a different device. In some embodiments, the input signal corresponds to sensor data obtained from a sensor device including one or more sensors. In some embodiments, the sensor device is an IMU device including one or more IMU sensors. For example, the one or more IMU sensors can include at least one of: an accelerometer, a gyroscope, a magnetometer, etc.

At block 420, processing logic extracts a set of features using input signal. In some embodiments, the set of features includes a set of confidence features and a set of uncertainty features. For example, the set of confidence features can be a set of mean-based features and the set of uncertainty features can be a set of variance-based features. In some embodiments, the set of features includes a set of feature vectors. In some embodiments, the set of feature vectors includes a confidence feature vector and an uncertainty feature vector. For example, the confidence feature vector can be a mean-based feature vector, and the uncertainty feature vector can be a variance-based feature vector.

At block 430, processing logic generates a set of feature tracking data from the set of features. The set of feature tracking data is generated to track the set of features and associated uncertainty. In some embodiments, generating the set of feature tracking data includes performing classification gating to generate a classification gating output, and recursively tracking the set of features and associated uncertainty based on the classification gating output.

In some embodiments, the set of feature tracking data includes a set of confidence feature tracking data and a set of uncertainty feature tracking data. For example, the set of confidence feature tracking data can be a set of mean-based tracking data, and the set of uncertainty feature tracking data can be a set of variance-based tracking data. In some embodiments, the set of feature tracking data includes a set of feature tracking vectors. In some embodiments, the set of feature vectors includes a confidence feature tracking vector and an uncertainty feature tracking vector. For example, the confidence feature tracking vector can be a mean-based feature tracking vector, and the uncertainty feature tracking vector can be a variance-based feature tracking vector.

At block 440, processing logic uses a machine learning model to make a prediction based on the set of feature tracking data. In some embodiments, using a machine learning model to make a prediction includes training the machine learning model during a training stage to obtain a trained model. In some embodiments, using a machine learning model to make a prediction includes making the prediction during an inference stage. In some embodiments, the machine learning model is a classifier. For example, making a prediction can include predicting a class. In some embodiments, the machine learning model is an FC-BNN model.

In some embodiments, the machine learning model makes an activity prediction based on the set of feature tracking data. In some embodiments, the activity is a human activity. The activity can be a known activity associated with a known activity class, or an unknown activity associated with an unknown activity class. For example, predicting an activity can include predicting an activity class. In some embodiments, the activity is a human activity.

In some embodiments, using a machine learning model to make a prediction includes compressing the machine learning model to obtain a compressed model. The compressed model can improve the efficiency of the machine learning model by reducing the size of the feature space used to make the prediction. For example, compressing the machine learning model can include identifying a subset of features based on the set of feature tracking data, and implementing the machine learning model based on the subset of features. For example, compressing the machine learning model can include generating the subset of features based on a set of model compression parameters. Each model compression parameter of the set of model compression parameters can correspond to a respective feature, and each feature can be added or removed from the set of features based on the respective model compression parameter.

In some embodiments, the set of model compression parameters includes a set of Shapley values. Generating the subset of features can include determining, for each feature, whether the respective Shapley value satisfies a threshold condition (e.g., is greater than or equal to a threshold value). If so, the feature can be added to the subset of features. If not, the feature is not included in the subset of features. That is, the feature is not used to implement the machine learning model (e.g., train the machine learning model). Accordingly, the subset of features can have a reduced dimensionality as compared to the set of features. Further details regarding blocks 410-440 are described above with reference to FIGS. 1-3.

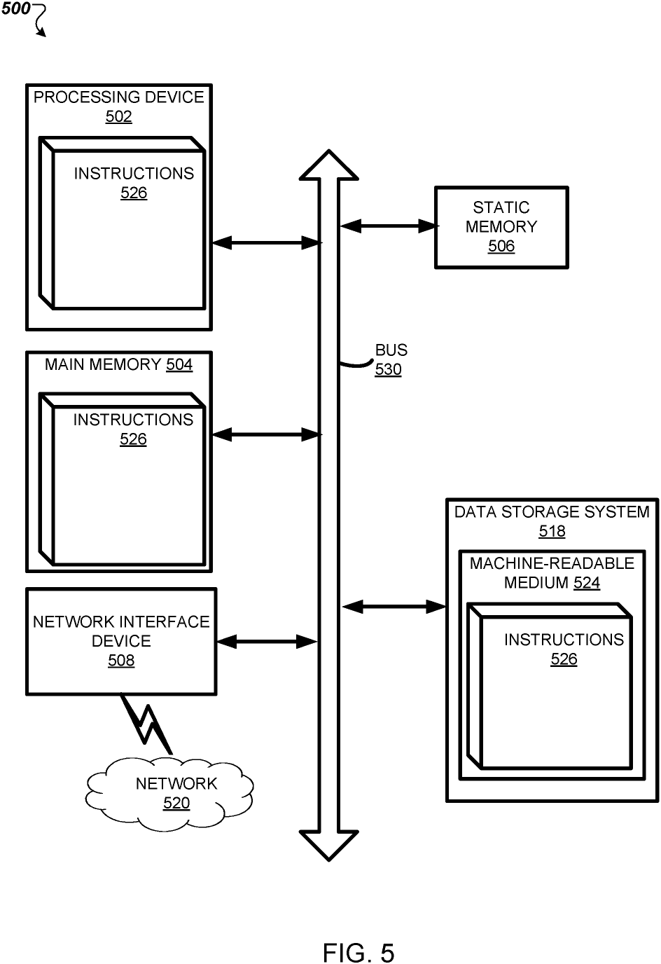

FIG. 5 illustrates an example machine of a computer system 500 within which a set of instructions, for causing the machine to perform any one or more of the methodologies discussed herein, can be executed. In some embodiments, the computer system 500 can correspond to a computing device that can be used to perform the operations of an activity recognition system (e.g., the prediction system 120 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the prediction system 120 of FIG. 1.

In one embodiment, the instructions 526 include instructions to implement functionality corresponding to the prediction system 120 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “allocating,” “dynamically allocating,” “redistributing,” “ignoring,” “reallocating,” “detecting,” “performing,” “polling,” “registering,” “monitoring,” or the like, refer to the actions and processes of a computing system, or similar electronic computing device, that manipulates and transforms data represented as physical (e.g., electronic) quantities within the computing system’s registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
memory; and
a processing device, operatively coupled to the memory, to:
obtain an input signal corresponding to data obtained from a data source;
extract a set of features using the input signal, wherein the set of features comprises a set of confidence features and a set of uncertainty features;
generate a set of feature tracking data from the set of features, wherein the set of feature tracking data comprises a set of confidence feature tracking data and a set of uncertainty feature tracking data;
compress a machine learning model to obtain a compressed model by identifying a subset of features based on the set of tracking data; and
use the compressed model to make a prediction.

2. The system of claim 1, wherein, to obtain the input signal, the processing device is to:
receive raw data from the data source; and
generate the input signal from the raw data.

3. The system of claim 1, wherein the data source comprises a sensor device comprising one or more sensors and the prediction is an activity prediction associated with an object.

4. The system of claim 1, wherein:
the set of confidence features comprises a set of mean-based features;
the set of uncertainty features comprises a set of variance-based features;
the set of confidence feature tracking data comprises a set of mean-based feature tracking data; and
the set of uncertainty feature tracking data comprises a set of variance-based feature tracking data.

5. The system of claim 1, wherein, to generate the set of feature tracking data, the processing device is to:
performing classification gating to generate a classification gating output; and
recursively tracking the set of features and associated uncertainty based on the classification gating output.

6. The system of claim 1, wherein, to use the compressed model to make the prediction, the processing device is to train the compressed model during a training stage to obtain a trained model.

7. The system of claim 1, wherein, to use the compressed model to make the prediction, the processing device is to make the prediction during an inference stage.

8. The system of claim 1, wherein, to compress the machine learning model, the processing device is to generate the subset of features based on a set of model compression parameters, and wherein each model compression parameter of the set of model compression parameters corresponds to a respective feature of the set of features.

9. The system of claim 8, wherein the set of model compression parameters comprises a set of Shapley values, and wherein, to generate the subset of features, the processing device is to:
determine, for each feature, whether a respective Shapley value satisfies a threshold condition; and
in response to determining that the Shapley value satisfies the threshold condition, add the feature to the subset of features.

10. A method comprising:
obtaining, by at least one processing device, an input signal corresponding to data obtained from a data source;
extracting, by the at least one processing device, a set of features using the input signal, wherein the set of features comprises a set of confidence features and a set of uncertainty features;
generating, by the at least one processing device, a set of feature tracking data from the set of features, wherein the set of feature tracking data comprises a set of confidence feature tracking data and a set of uncertainty feature tracking data;
compressing, by the at least one processing device, a machine learning model to obtain a compressed model by identifying a subset of features based on the set of tracking data; and
using, by at least one processing device, the compressed model to make a prediction.

11. The method of claim 10, wherein obtaining the input signal comprises:
receiving raw data from the data source; and
generating the input signal from the raw data.

12. The method of claim 10, wherein the data source comprises a sensor device comprising one or more sensors and the prediction is an activity prediction associated with an object.

13. The method of claim 10, wherein:
the set of confidence features comprises a set of mean-based features;
the set of uncertainty features comprises a set of variance-based features;
the set of confidence feature tracking data comprises a set of mean-based feature tracking data; and
the set of uncertainty feature tracking data comprises a set of variance-based feature tracking data.

14. The method of claim 10, wherein generating the set of feature tracking data comprises:
performing classification gating to generate a classification gating output; and
recursively tracking the set of features and associated uncertainty based on the classification gating output.

15. The method of claim 10, wherein using the machine learning model to make the prediction further comprises training the machine learning model during a training stage to obtain a trained model.

16. The method of claim 10, wherein using the machine learning model to make the prediction further comprises making the prediction during an inference stage.

17. The method of claim 10, wherein compressing the machine learning model comprises generating the subset of features based on a set of model compression parameters, and wherein each model compression parameter of the set of model compression parameters corresponds to a respective feature of the set of features.

18. The method of claim 17, wherein the set of model compression parameters comprises a set of Shapley values, and wherein generating the subset of features comprises:
determining, for each feature, whether a respective Shapley value satisfies a threshold condition; and
in response to determining that the Shapley value satisfies the threshold condition, adding the feature to the subset of features.

19. A non-transitory computer-readable storage medium comprising instructions that, when executed by a processing device, cause the processing device to:
obtain an input signal corresponding to data obtained from a data source;
extract a set of features using the input signal, wherein the set of features comprises a set of confidence features and a set of uncertainty features;
generate a set of feature tracking data from the set of features, wherein the set of feature tracking data comprises a set of confidence feature tracking data and a set of uncertainty feature tracking data;
compress a machine learning model to obtain a compressed model by identifying a subset of features based on the set of tracking data; and
use the compressed model to make a prediction.

20. The non-transitory computer-readable storage medium of claim 19, wherein, to compress the machine learning model, the processing device is to generate the subset of features based on a set of model compression parameters, and wherein each model compression parameter of the set of model compression parameters corresponds to a respective feature of the set of features.
